(19) United States
(12) Patent Application Publication
(10) Pub. No.: US 2022/0363823 A1
(43) Pub. Date: Nov. 17, 2022

(54) RECOVERY AND REUSE OF ACTIVATORS AND INITIATORS FOLLOWING POLYCARBONATE SYNTHESIS

(71) Applicant: King Abdullah University of Science and Technology, Thuwal (SA)

(72) Inventors: Xiaoshuang FENG, Thuwal (SA); Naganatha PATIL, Thuwal (SA); Senthil BOOPATHI, Thuwal (SA); Yves GNANOU, Thuwal (SA); Nikolaos HADJICHRISTIDIS, Thuwal (SA)

(21) Appl. No.: 17/620,360

(22) PCT Filed: Jul. 2, 2020
(86) PCT No.: PCT/IB2020/056267

§ 371 Date: Dec. 17, 2021

Related U.S. Application Data
(60) Provisional application No. 62/871,034, filed on Jul. 5, 2019.
(60) Provisional application No. 62/901,862, filed on Sep. 18, 2019.

(51) Int. Cl. C08G 64/34; C08J 11/02; C08G 64/40

(52) U.S. Cl. CPC C08G 64/34; C08J 11/02; C08G 64/40; C08J 2369/00

(57) ABSTRACT

Methods of recovering and/or reusing activators and/or initiators following polycarbonate synthesis may include: contacting an amine compound with a carboxylic acid compound to form a first ammonium salt including a first ammonium cation associated with a carboxylate group; mixing the first ammonium salt with a reaction solution to obtain a first solution comprising a protonated polycarbonate, an activator adduct, and a second ammonium salt in which the second ammonium cation is associated with the carboxylate group from the first ammonium salt; contacting the first solution to precipitate the polycarbonate out of solution; separating the activator adduct from the precipitated polycarbonate and the second ammonium salt to obtain a second solution; separating the precipitated polycarbonate from the second ammonium salt to recover the second ammonium salt; and separating the activator adduct from the second solution to recover an activator capable of being reused for synthesizing additional polycarbonates.

### BACKGROUND OF THE INVENTION

Polycarbonate diols and polycarbonate polyols of low molar masses are attracting interest as precursors in applications. For example, where used as precursors in polyurethane synthesis, the resulting polyurethanes exhibit better performance and reduce the carbon footprint when generated from polycarbonate polyol in comparison to polyether polyols or polyester polyols. To be suitable for such applications, polycarbonate polyols are required to exhibit well-defined terminal hydroxyl functionality, low polydispersity, and tunable carbonate contents.

While progress has been made in the preparation of polycarbonates of high molar mass and carbonate content, the preparation of low molar mass polycarbonate polyols with defined structures is still challenging. Where heterogeneous catalysts, such as double metal cyanide (DMC), are used to prepare polycarbonate diols, protic transfer agents such as alcohols and acids are required. Although the chain ends of such polycarbonate samples possess the expected hydroxyl functionality, they generally suffer from a low carbonate content, linear versus cyclic selectivity, and a broad polydispersity.

Polycarbonate polyols have also been prepared using homogeneous catalysts based on cobalt, zinc or magnesium. In these cases, the polycarbonate polyols possessed high carbonate content and narrow polydispersity, but, due to the association of anion with the metal center, the chain-end resulting from initiation by the nucleophile carried by the catalyst is blocked by a functional group other than hydroxyl and thus the polycarbonate polyols obtained are contaminated with mono-hydroxyl chains, undesirable for polyurethane applications. As clearly demonstrated in one report, polycarbonate tetrol and hexeol samples, prepared in the presence of tetra- and hexafunctional carboxylic acids, using tetraphenylporphyrinatocobalt (III) chloride as a catalyst, were contaminated with linear polycarbonates chains that had to be removed by fractionation. To address this issue, the ligand must be modified to be a polymerization initiator which carries multi-functional group.

Polycarbonate diols have also been obtained by another strategy to prepare a polycarbonate with a higher molar mass (80 to 100 kg/mol), followed by alcoholysis in the presence of “molecular” diols and an inorganic catalyst. These strategies require harsh conditions, which eventually afforded polycarbonate diol samples of broad molar mass distribution with cyclic by-products.

### SUMMARY OF THE INVENTION

Methods of recovering activators and initiators capable of being utilized in the synthesis of polycarbonate polyols are disclosed herein. Once recovered, the activators and initiators can be reused in the synthesis of additional polycarbonates.

In a first aspect, the present invention is directed to a method of recovering and optionally reusing an activator and initiator following polycarbonate synthesis, comprising one or more of the following steps:

(a) contacting an amine compound with a carboxylic acid compound in small quantity of water to form a first ammonium salt, the first ammonium salt including a first ammonium cation associated with a carboxylate group;

(b) mixing the first ammonium salt with a diluted reaction solution comprising a crude polycarbonate with an activator-second ammonium cation complex attached to at least one chain end to obtain a first solution comprising a protonated polycarbonate, an activator adduct, and a second ammonium salt in which the second ammonium cation is associated with the carboxylate group from the first ammonium salt;

(c) contacting the first solution with a non-solvent to precipitate the polycarbonate and second ammonium salt out of solution;

(d) separating the activator adduct from the precipitated polycarbonate and second ammonium salt to obtain a second solution including the activator adduct;

(e) separating the second ammonium salt from the precipitated polycarbonate through selective extraction to recover the second ammonium salt, wherein the second ammonium salt is capable of being reused as an initiator for synthesizing additional polycarbonates; and

(f) separating the activator adduct from the second solution to recover an activator capable of being reused for synthesizing additional polycarbonates, wherein the separating includes treating with an isocyanate compound.

In certain embodiments, the amine compound is selected from the group consisting of primary amines, secondary amines, tertiary amines, or aromatic amines. In certain embodiments, the amine compound has the following formula:

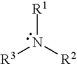

where each of R¹, R², and R³ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl.

In certain embodiments, the carboxylic acid compound includes mono-functional carboxylic acids or poly-functional carboxylic acids. In certain embodiments, the carboxylic acid compound has the following formula:

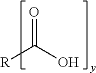

wherein R is substituted and unsubstituted alkyl, substituted and unsubstituted heteroalkyl, substituted and unsubstituted alkenyl, substituted or unsubstituted alkynyl, substituted and unsubstituted aryl, substituted and unsubstituted heteroaryl, substituted and unsubstituted aralkyl, or substituted and unsubstituted alkaryl; and y is the functionality of the carboxylic acid compound and is at least 1.

In certain embodiments, the first ammonium salt has the following formula:

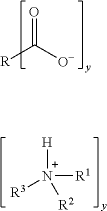

where each of R, R¹, R², and R³ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl; and y is at least 1.

In certain embodiments, the activator adduct includes an activator and the amine compound. In certain embodiments, the activator is selected from the group consisting of triethyl borane, tributyl borane, triisobutyl borane, trioctyl borane, or triphenyl borane.

In certain embodiments, the second ammonium cation is selected from the group consisting of NBu₄⁺, NPh₄⁺, NOct₄⁺, and N(allyl)₂(Me)₂⁺. In certain embodiments, the second ammonium salt has the following formula:

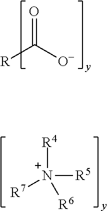

where each of R, R⁴, R⁵, R⁶, and R⁷ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl; and y is at least 1. In certain embodiments, the first ammonium cation and second ammonium cation are different.

In certain embodiments, the separating in step (d) proceeds by centrifuging to obtain phase separable layers comprising a first layer and a second layer, wherein the first layer includes the precipitated polycarbonate and second ammonium salt and the second layer includes the activator adduct.

In certain embodiments, the separating in step (e) proceeds by re-dissolving the polycarbonate and subsequently contacting with a non-solvent to re-precipitate the polycarbonate out of solution, leaving the second ammonium salt in solution. In certain embodiments, the separating in step (e) further proceeds by lyophilizing the second ammonium salt in solution to recover the second ammonium salt therefrom.

In certain embodiments, the separating in step (f) proceeds by distilling the second solution to obtain a distillate residue. In certain embodiments, the distillate residue is treated with the isocyanate compound to recover the activator. In certain embodiments, the isocyanate compound includes tosyl isocyanate, alkyl isocyanates, and aromatic isocyanates. In certain embodiments, the isocyanate compound has the following formula:

R⁸ [symbol] +N═C═O]ₓ

where R⁸ is selected from substituted or unsubstituted tosyl, substituted or unsubstituted alkyl, and substituted or unsubstituted aryl; x is at least 1.

In certain embodiments, the method further comprises contacting an epoxide and carbon dioxide in the presence of the recovered initiator and activator to form polycarbonates.

In certain embodiments, wherein the epoxide is selected from one of the following:

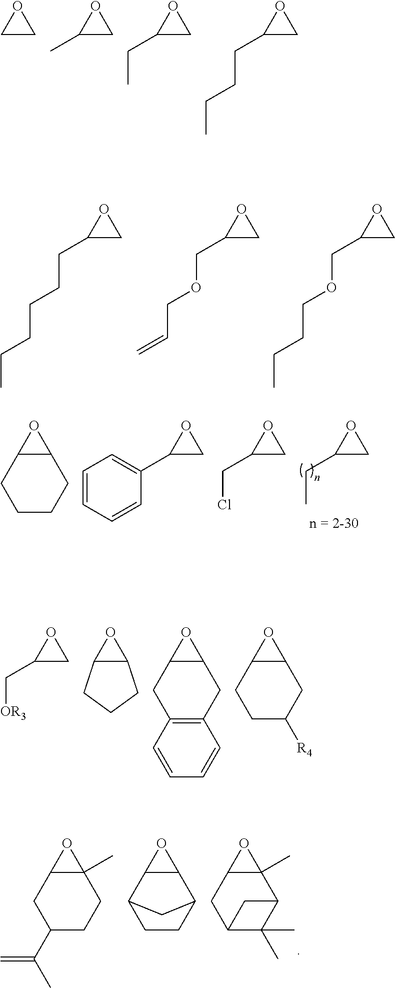

The details of one or more examples are set forth in the description below. Other features, objects, and advantages will be apparent from the description and from the claims.

### BRIEF DESCRIPTION OF THE DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of recovering (and optionally reusing) an activator and initiator following polycarbonate synthesis, according to one or more embodiments of the present disclosure.

FIG. 2 is a flowchart of a method of recovering ammonium succinate as initiator and triethyl borane as activator following synthesis of difunctional polypropylene carbonate, according to one or more embodiments of the present disclosure.

FIG. 2 is a flowchart of a method of a recycling process in which triethyl borane and tetrabutylammonium cations are simultaneously recovered and/or recycled in the preparation of polycarbonate polyol, according to one or more embodiments of the present disclosure.

### DETAILED DESCRIPTION

### Definitions

The terms recited below have been defined as described below. All other terms and phrases in this disclosure shall be construed according to their ordinary meaning as understood by one of skill in the art.

As used herein, the term “polycarbonate” refers to any product resulting from the polymerization of carbon dioxide and epoxides. The polymerization can optionally proceed in the presence of at least one of an activator and initiator. The term “polycarbonates” includes crude, intermediate, and purified forms thereof. Examples of said polycarbonates include, but are not limited to, polycarbonates, polycarbonate polyols, polyethers, and the like.

As used herein, the term “solution” refers to any fluid medium and includes both solvents and non-solvents. Examples of suitable solutions include, but are not limited to, acetone, acetic acid, acetonitrile, benzene, n-butanol, 2-butanone, butyl acetate, carbon tetrachloride, chloroform, cyclohexane, 1,2-dichloroethane, dichloromethane, diethyl ether, dimethyl formamide, dimethyl sulfoxide, 1,4-dioxane, ethanol, ethyl acetate, heptane, hexane, methanol, methyl-t-butyl ether, pentane, diisopropyl ether, 1-propanol, 2-propanol, tetrahydrofuran, toluene, 2,2,4-trimethylpentane, trichloroethylene, xylene, water, and air.

As used herein, the term “solvent” generally refers to any solution capable of dissolving one or more chemical species, such as the polycarbonates as defined herein, which include polycarbonate polyols, among others. One example of a suitable solvent includes tetrahydrofuran, among others.

As used herein, the term “non-solvent” generally refers to any solution capable of precipitating a polymer, such as the polycarbonates disclosed herein, which include polycarbonate polyols, among others. Examples of suitable non-solvents include, but are not limited to, hexane, heptane, benzene, toluene, acetone, water and the like.

When used in the context of a chemical group, “hydrogen” means —H; “carboxyl” means —COOH; “hydroxy” means —OH; “oxo” means ═O; “halo” means independently —F, —Cl, —Br or —I; “hydroxyamino” means —NHOH; “nitro” means —NO₂; “cyano” means —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; “thio” means ═S; “thioether” means ═S—; “sulfonamido” means —NHS(O)₂—; “sulfonyl” means —S(O)₂—; and “sulfinyl” means —S(O)—.

As used herein, the term “substituted” refers to all permissible substituents of the compounds described herein. In the broadest sense, the permissible substituents include acyclic and cyclic, branched and unbranched, carbocyclic and heterocyclic, aromatic and nonaromatic substituents of organic compounds. Non-limiting examples of substituents include halogens, hydroxyl groups, or any other organic groupings containing any number of carbon atoms and optionally include one or more heteroatoms such as oxygen, nitrogen, or sulfur grouping in linear, branched, or cyclic structural formats.

Examples of substituents include, without limitation, halo, hydroxyl, alkyl, substituted alkyl, alkenyl, substituted alkenyl, alkynyl, substituted alkynyl, phenyl, substituted phenyl, aryl, substituted aryl, heteroaryl, substituted heteroaryl, alkoxy, substituted alkoxy, phenoxy, substituted phenoxy, aryloxy, substituted aryloxy, aralkoxy, substituted aralkoxy, alkenyloxy, substituted alkenyloxy, alkynyloxy, substituted alkynyloxy, heteroaryloxy, substituted heteroaryloxy, acyloxy, substituted acyloxy, carbonyl, substituted carbonyl, carboxyl, substituted carboxyl, amino, substituted amino, amido, substituted amido, sulfonyl, substituted sulfonyl, arylsulfonyl, substituted arylsulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, and amino acid groups.

As used herein, “heteroatom” means an atom of any element other than carbon or hydrogen. Examples of heteroatoms include nitrogen, oxygen, boron, phosphorus, and sulfur. As discussed herein, heteroatoms, such as nitrogen, may have hydrogen substituents and/or any permissible substituents of organic compounds described herein which satisfy the valences of the heteroatoms.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl). When the term “aliphatic” is used without the “substituted” modifier only carbon and hydrogen atoms are present. When the term is used with the “substituted” modifier one or more hydrogen atom has been independently replaced by any of the substituents disclosed herein.

As used herein, the term “alkyl” when used without the “substituted” modifier refers to an alkane with one or more hydrogen atoms removed and includes straight chain alkyl groups, branched chain alkyl groups, cycloalkyl (alicyclic) groups, alkyl-substituted cycloalkyl groups, and cycloalkyl-substituted alkyl groups. A straight chain or branched chain alkyl has 30 or fewer carbon atoms in its backbone (e.g., C₁-C₃₀ for straight chains, and C₃-C₃₀ for branched chains). Cycloalkyls have 3-10 carbon atoms in their ring, preferably 5-6 carbons in the ring. The groups —CH₃ (Me), —CH₂CH₃ (Et), —CH₂CH₂CH₃ (n-Pr), —CH(CH₃)₂(iso-Pr), —CH(CH₂)₂(cyclopropyl), —CH₂CH₂CH₂CH₃ (n-Bu), —CH(CH₃)CH₂CH₃ (sec-butyl), —CH₂CH(CH₃)₂(iso-butyl), —C(CH₃)₃(tert-butyl), —CH₂C(CH₃)₃(neo-pentyl), 2-ethylhexyl, cyclopropyl, cyclobutyl, cyclopentyl, cyclohexyl, and cyclohexylmethyl are non-limiting examples of alkyl groups. When these terms are used with the “substituted” modifier one or more hydrogen atom has been independently replaced by any of the substituents disclosed herein.

Any of the foregoing alkyl groups can have one or more points of attachment, for example, by removal of one or more hydrogen atoms (e.g., can be divalent, trivalent, tetravalent, etc. radicals). For example, the group —CH₂CH₃ (Et) from above can also be represented as —CH₂CH₃-(Et), without departing from the scope of the present invention. This applies to alkyls and all examples of alkyls, and all other groups disclosed and/or defined herein, including, without limitation, the groups defined below, which include heteroalkyls, alkenyls, alkynyls, aryls, heteroaryls, aralkyls, alkaryls, haloaryls, alkoxys, alkenyloxys, alkynyloxys, aryloxys, aralkoxys, heteroaryloxys, acyloxys, acyls, and the like, whether substituted or unsubstituted.

As used herein, the term “heteroalkyl” refers to straight or branched chain, or cyclic carbon containing radicals, or combinations thereof, containing at least one heteroatom. Suitable heteroatoms include, but are not limited to, O, N, Si, P, Se, B, and S. Heteroalkyls can be substituted as defined above for alkyl groups.

As used herein, the term “alkenyl” when used without the “substituted” modifier refers to a straight- or branched-chain hydrocarbon moiety having at least one carbon-carbon double bond. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, —CH═CH—C₆H₅, —CH═CH—, —CH═C(CH₃)CH₂—, and —CH═CHCH₂—. The groups, —CH═CHF, —CH═CHCl and —CH═CHBr, are non-limiting examples of substituted alkenyl groups. The term includes alkenyls having one or more (e.g., two, three, four, etc.) points of attachment, including the examples provided above. When these terms are used with the “substituted” modifier one or more hydrogen atom has been independently replaced by any of the substituents disclosed herein. An “alkene” refers to the compound H—R, wherein R is alkenyl.

As used herein, the term “alkynyl” when used without the “substituted” modifier refers to a straight- or branched-chain hydrocarbon moiety having at least one carbon-carbon triple bond. As used herein, the term alkynyl does not preclude the presence of one or more non-aromatic carbon-carbon double bonds. The groups —C≡CH, —C≡CCH₃, and —CH₂C≡CCH₃, are non-limiting examples of alkynyl groups. The term includes alkynyls having one or more (e.g., two, three, four, etc.) points of attachment, including the examples provided above. When these terms are used with the “substituted” modifier one or more hydrogen atom has been independently replaced by any of the substituents disclosed herein. An “alkyne” refers to the compound H—R, wherein R is alkynyl.

As used herein, the term “aryl” when used without the “substituted” modifier refers to a monocyclic or polycyclic aromatic group with carbon atoms forming an aromatic ring structure, wherein the ring atoms are all carbon, and wherein the group consists of no atoms other than carbon and hydrogen. If more than one ring is present, the rings may be fused or not fused. As used herein, the term does not preclude the presence of one or more alkyl groups attached to the first aromatic ring or any additional aromatic ring present. The point of attachment can be an aromatic carbon atom in the ring structure or a carbon atom of an alkyl group attached to the ring structure. Non-limiting examples of aryl groups include phenyl (Ph), toyl, xylyl, methylphenyl, (dimethyl)phenyl, —C₆H₄—CH₂CH₃ (ethylphenyl), naphthyl, and the monovalent group derived from biphenyl. The term includes aryls having one or more (e.g., two, three, four, etc.) points of attachment, including the examples provided above. When these terms are used with the “substituted” modifier one or more hydrogen atom has been independently replaced by any of the substituents disclosed herein. An “arene” refers to the compound H—R, wherein R is aryl.

As used herein, the term “heteroaryl” when used without the “substituted” modifier refers to a monocyclic or polycyclic aromatic group with one or more aromatic non-carbon atoms forming at least part of an aromatic ring structure. Non-limiting examples of non-carbon atoms in the aromatic ring structure include nitrogen, oxygen, and sulfur. As used herein, the term does not preclude the presence of one or more alkyl group (carbon number limitation permitting) attached to the aromatic ring or any additional aromatic ring present. The point of attachment can be an aromatic carbon or non-carbon atom in the aromatic ring structure or a carbon atom of an alkyl group attached to the aromatic ring structure. Non-limiting examples of heteroaryl groups include furanyl, imidazolyl, indolyl, indazolyl, methylpyridyl, oxazolyl, pyridyl, pyrrolyl, pyrimidyl, pyrazinyl, quinolyl, quinazolyl, quinoxalinyl, thienyl, and triazinyl. The term includes heteroaryls having one or more (e.g., two, three, four, etc.) points of attachment, including the examples provided above. Heteroaryls can be substituted as defined above for aryl groups.

The term “aralkyl” when used without the “substituted” modifier refers to an alkyl as previously defined, wherein one or more of the hydrogen atoms is replaced by an aryl and/or heteroaryl group as defined above. Non-limiting examples of aralkyls are: phenylmethyl (benzyl, Bn) and 2-phenyl-ethyl. The point of attachment can be an aromatic carbon atom in the ring structure or a carbon atom of an alkyl group attached to the ring structure. The term includes aralkyls having one or more (e.g., two, three, four, etc.) points of attachment, including the examples provided above. When these terms are used with the “substituted” modifier one or more hydrogen atom has been independently replaced by any of the substituents disclosed herein.

As used herein, the term “alkaryl” when used without the “substituted” modifier refers to an aryl and/or heteroaryl group as described herein, wherein one or more of the hydrogen atoms is replaced by an alkyl and/or heteroalkyl group as defined herein. The point of attachment can be an aromatic carbon atom in the ring structure or a carbon atom of an alkyl group attached to the ring structure. The term includes alkaryls having one or more (e.g., two, three, four, etc.) points of attachment, including the examples provided above. When these terms are used with the “substituted” modifier one or more hydrogen atom has been independently replaced any of the substituents disclosed herein.

As used herein, the term “haloaryl” when used without the “substituted” modifier refers to an aryl and/or heteroaryl group as defined herein, wherein one or more of the hydrogen atoms is replaced by a halogen as described herein. The point of attachment can be an aromatic carbon atom in the ring structure or a carbon atom of an alkyl group attached to the ring structure. The term includes haloaryls having one or more (e.g., two, three, four, etc.) points of attachment, including the examples provided above. When these terms are used with the “substituted” modifier one or more hydrogen atom has been independently replaced by any of the substituents disclosed herein.

As used herein, the term “alkoxy” when used without the “substituted” modifier refers to the group —OR, wherein R is an alkyl and/or heteroalkyl as defined herein. Non-limiting examples of alkoxy groups include: —OCH₃, —OCH₂CH₃, —OCH₂CH₂CH₃, —OCH(CH₃)₂, —OCH(CH₂)₂, —OC₃H₆, —OC₄H₈, —OC₅H₁₀, —OC₆H₁₂, —OCH₂C₃H₆, —OCH₂C₄H₈, —OCH₂C₅H₁₀, —OCH₂C₆H₁₂, and the like. The term includes alkoxys having one or more (e.g., two, three, four, etc.) points of attachment, including the examples provided above. When any of these terms is used with the “substituted” modifier, one or more hydrogen atoms have been independently replaced by any of the substituents disclosed herein.

As used herein, the terms “alkenyloxy”, “alkynyloxy”, “aryloxy”, “aralkoxy”, “heteroaryloxy”, and “acyloxy”, when used without the “substituted” modifier, refers to groups, defined as —OR, in which R is alkenyl, alkynyl, aryl, aralkyl, heteroaryl, and acyl, respectively. Examples include without limitation aryloxy groups such as —O-Ph and aralkoxy groups such as —OCH₂-Ph (—OBn) and —OCH₂CH₂-Ph. The term includes alkenyloxy, alkynyloxy, aryloxy, aralkoxy, heteroaryloxy, and acyloxy, each independently having one or more (e.g., two, three, four, etc.) points of attachment, including the examples provided above. When any of these terms is used with the “substituted” modifier, one or more hydrogen atoms have been independently replaced by any of the substituents disclosed herein.

As used herein, the term “acyl” when used without the “substituted” modifier refers to the group —C(O)R, in which R is a hydrogen, alkyl, aryl, aralkyl or heteroaryl, as those terms are defined above. Non-limiting examples of acyl groups include: —CHO, —C(O)CH₃ (acetyl, Ac), —C(O)CH₂CH₃, —C(O)CH₂CH₂CH₃, —C(O)CH(CH₃)₂, —C(O)CH(CH₂)₂, —C(O)C₆H₅, —C(O)C₆H₄—CH₃, —C(O)CH₂C₆H₅, and —C(O)(imidazolyl). The term includes acyls having one or more (e.g., two, three, four, etc.) points of attachment, including the examples provided above. When any of these terms is used with the “substituted” modifier, one or more hydrogen atoms have been independently replaced by any of the substituents disclosed herein. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

As used herein, the term “halide” or “halo” or “halogen” refers to —F, —Cl, —Br, or —I.

Methods of recovering activators and initiators capable of being utilized in the synthesis of polycarbonate polyols are disclosed herein. Once recovered, the activators and initiators can be reused in the synthesis of additional polycarbonates. In general, the methods disclosed herein comprise the steps of forming a first ammonium salt from a carboxylic acid compound and amine compound; contacting the first ammonium salt with a crude polycarbonate having an ate complex associated with at least one chain end to obtain a solution including a second ammonium salt, an activator adduct, and a protonated polycarbonate; precipitating the protonated polycarbonate in a non-solvent to obtain a precipitated polycarbonate; processing the solution further to recover the activator and precipitated to recover the second ammonium salt; and optionally contacting an epoxide and carbon dioxide in the presence of the recovered activator and second ammonium salt, or initiator, to form polycarbonates.

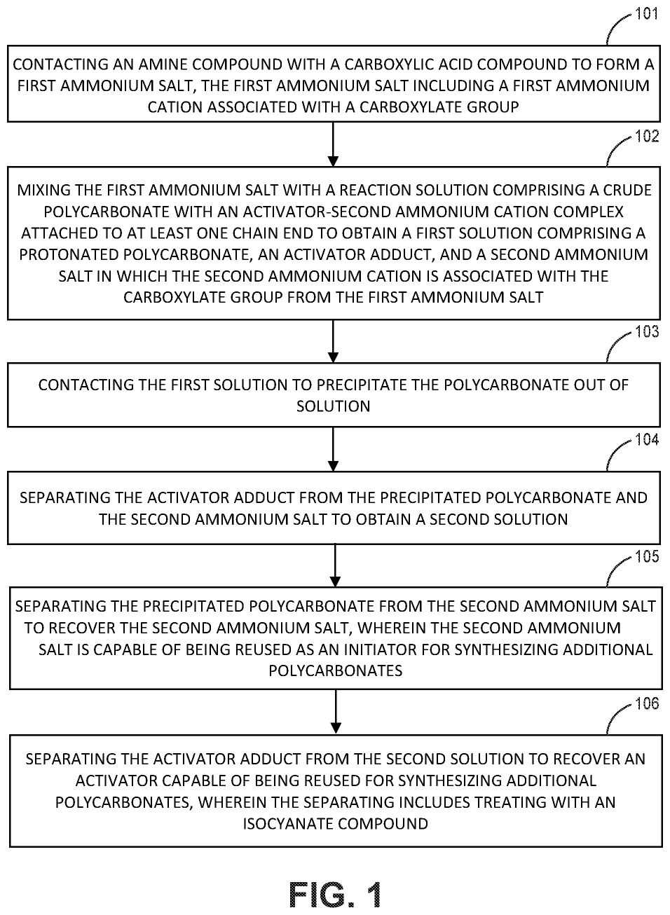

FIG. 1, for example, presents a flowchart of a method of recovering and optionally reusing an activator and initiator following polycarbonate synthesis, according to one or more embodiments of the present disclosure. As shown in FIG. 1, the method may include one or more of the following steps, which may be performed simultaneously or sequentially, in any order: contacting 101 an amine compound with a carboxylic acid compound to form a first ammonium salt, the first ammonium salt including a first ammonium cation associated with a carboxylate group (step (a)); mixing 102 the first ammonium salt with a reaction solution comprising a crude polycarbonate with an activator-second ammonium cation complex attached to at least one chain end to obtain a first solution comprising a protonated polycarbonate, an activator adduct, and a second ammonium salt in which the second ammonium cation is associated with the carboxylate group from the first ammonium salt (step (b)); contacting 103 the first solution to precipitate the polycarbonate out of solution (step (c)); separating 104 the activator adduct from the precipitated polycarbonate and the second ammonium salt to obtain a second solution (step (d)); separating 105 the precipitated polycarbonate from the second ammonium salt to recover the second ammonium salt, wherein the second ammonium salt is capable of being reused as an initiator for synthesizing additional polycarbonates (step (e)); and separating 106 the activator adduct from the second solution to recover an activator capable of being reused for synthesizing additional polycarbonates, wherein the separating includes treating with an isocyanate compound (step (f)).

In step (a), an amine compound is contacted with a carboxylic acid compound to form a first ammonium salt, wherein the first ammonium salt includes at least one ammonium cation associated with at least one carboxylate group. The contacting can proceed in a solution or solution mixture at or under any conditions suitable for generating the first ammonium salt. In some embodiments, the contacting proceeds in an aqueous solution, or a small quantity of water. Preferably, the contacting is sufficient to deprotonate each of the one or more carboxyl groups of the carboxylic acid compound and transfer the proton from said carboxyl groups to the amine compound to form the first ammonium salt, wherein each carboxylate group formed is balanced by an ammonium cation. Accordingly, in certain embodiments, the contacting can proceed with stoichiometric ratios of amine compound to carboxylic acid compound. It would also be permissible, but not required, for the amine compound to be provided in stoichiometric excess of the carboxylic acid compound. In other embodiments, the contacting proceeds with sub-stoichiometric ratios of the amine compound to carboxylic acid compound.

The amine compound can include any compound comprising an amine capable of reacting with a carboxylic acid compound to form an ammonium salt as disclosed herein. The amine compound can include primary amines, secondary amines, tertiary amines, aromatic amines, and the like. In some embodiments, the amine compound is a compound of the formula:

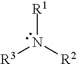

where each of R¹, R², and R³ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, substituted or unsubstituted alkaryl, and the like. In certain embodiments, at least one of R¹, R², and R³ is a substituted aryl or substituted alkyl comprising one or more amino substituents.

Examples of amine compounds include, but are not limited to, methylamine, ethylamine, propylamine, isopropylamine, butylamine, sec-butylamine, iso-butylamine, hexylamines, heptylamines, octylamines, nonylamines, decylamines, anilines, phenylene diamines, toluidines, diaminotoluenes, dimethylamine, diethylamine, dipropylamine, diisopropylamine, dibutylamine, methylethylamine, propylbutylamine, diphenylamine, methylaniline, butylaniline, dibenzylamine, ethylbenzylamine, butylbenzylamine, dicyclohexylamine, trimethylamine, trimethylamine, tripropylamine, triisopropylamine, tributylamine, methyldiethylamine, methyldipropylamine, dimethylethylamine, methylethylpropylamine, methylethylaniline, methylisopropylaniline, dipropylaniline, methyldiphenylamine, ethyldiphenylamine, triphenylamine, diethylbenzylamine, dipropylbenzylamine, 1,2-diaminoethane (1,2-ethylene diamine), 1,2 diaminopropane, 1,3-diaminopropane, 1,2-diaminobutane, 1,3-diaminobutane, 1,4 diaminobutane, 1,2-diaminopentane, 1,3-diaminopentane, 1,4-diaminopentane, 1,5 10 diaminopentane, and similar higher diaminoalkanes, aminomethylcyclopentylamine, 1,2-cyclopentanediamine, 1,6-hexanediamine, 1,2-diaminobenzene, lysine (or other diamine amino acids), 1,2-diaminobenzene, 1,4-diamine benzene, 1,2-diphenyl-1,2 ethane diamine, phenylene diamine, 2-hydroxypropylene diamine, hydantoin, N,N Bis(dihydroxyethyl)ethylenediamine, hexahydrotriazine, aminoethylpiperazine, and the like.

The carboxylic acid compound can include any compound having at least one carboxyl group as defined herein. The carboxylic acid compounds include mono- and multi-functional (e.g., poly-functional) carboxylic acids. A mono-functional carboxylic acid is a carboxylic acid comprising only one carboxyl group. A multi-functional carboxylic acid is a carboxylic acid comprising two or more carboxyl groups. The carboxylic acids are characterized by a functionality, y, that can range from 1 to n, where a functionality of 1 refers to a mono-functional carboxylic acid or monocarboxylic acid, a functionality of 2 refers to a bifunctional carboxylic acid or dicarboxylic acid, a functionality of 3 refers to a trifunctional carboxylic acid or tricarboxylic acid, and so on. The upper bound of n is not particularly limited. Unless otherwise provided, the term “carboxylic acid” also includes carboxylates, or the conjugate base of a carboxylic acid or a carboxylic acid compound. The functionality of the carboxylic acid can be selected based on the desired functionality of any subsequent polycarbonates or polyethers to be formed following the recovery and recycling of the activator and initiator. For example, a tri-functional carboxylic acid utilized in this step (a) will result in the recovery of a tri-functional initiator that can be reused to form tri-functional polycarbonate polyols.

In some embodiments, the carboxylic acid compound has the formula:

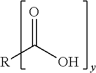

where R is not particularly limited and can include substituted and unsubstituted alkyl, substituted and unsubstituted heteroalkyl, substituted and unsubstituted alkenyl, substituted or unsubstituted alkynyl, substituted and unsubstituted aryl, substituted and unsubstituted heteroaryl, substituted and unsubstituted aralkyl, substituted and unsubstituted alkaryl, and the like; and y is the functionality of the carboxylic acid compound and is in the range of 1 to n. In some embodiments, for example, R includes an alkyl, wherein the alkyl is a C₁₊ alkyl, such as ethyl, which may be divalent; and y is 2. For example, in some embodiments, the carboxylic acid is succinic acid.

Examples of suitable carboxylic acid compounds include, but are not limited to, saturated aliphatic monocarboxylic acids, such as formic acid, acetic acid, propionic acid, butyric acid, valeric acid, caproic acid, pentanoic acid, caprylic acid and pelargonic; saturated aliphatic dicarboxylic acids, such as oxalic acid, malonic acid, succinic acid, glutaric acid, adipic acid, p-Mer acid, suberic acid, azelaic acid, sebacic acid, methyl succinic acid, 2,2-dimethyl succinic acid, 2,3-dimethylsuccinic acid, methylmalonic acid, α-methyl glutaric acid, β-methyl glutaric acid, 2,2-dimethyl glutaric acid, 2,4-dimethyl glutaric acid, 3,3-dimethyl glutaric acid, 2-ethyl-2-methyl succinic acid, 2,2,5,5-tetramethyl-hexanoic acid, and 3-methyl adipic acid; unsaturated aliphatic monocarboxylic acids, such as acrylic acid, crotonic acid, isocrotonic acid, vinyl acetate, and methacrylic acid; unsaturated aliphatic dicarboxylic acids, such as fumaric acid, maleic acid, methyl maleic acid, methyl fumaric acid, itaconic acid, citraconic acid, mesaconic acid, glutaconic acid, non-acid, 2-methyl-non-acid, acetylene dicarboxylic acid, oxalic acid, malonic acid, succinic acid, glutaric acid, adipic acid, pimelic acid, suberic acid, azelaic acid, sebacic acid, undecanedioic acid, dodecanedioic acid, and 1-propyn-1,3-dicarboxylic acid; aliphatic polycarboxylic acids, such as methane tricarboxylic acid, ethylene tricarboxylic acid, citric acid, isocitric acid, aconitic acid, propane-1,2,3-tricarboxylic acid, and trimesic acid; alicyclic monocarboxylic acids, such as cyclohexanecarboxylic acid, kolran acid, lithocholic acid and cholic acid; alicyclic dicarboxylic acids, such as 1,2-cyclohexanedicarboxylic acid, 1,3-cyclohexanedicarboxylic acid, 1,4-cyclohexanedicarboxylic acid and 3,3-tetramethylene glutaric acid; aromatic carboxylic acids, such as benzoic acid, toluic acid, kumsan, phthalic acid, isophthalic acid, and terephthalic acid. In some embodiments, the carboxylic acid is selected from acetic acid, propionic acid, acrylic acid, lactic acid, pyruvic acid, butyric acid, citric acid, succinic acid, fumaric acid, malic acid, itaconic acid, citric acid, or gluconic acid. In certain embodiments, the carboxylic acid compound is succinic acid.

The molar ratio of the amine compound to the carboxylic acid compound can be in the range of 0.01:100 to about 100:0.01.

The amine compound and carboxylic acid compound can be contacted in solution. Any fluid medium in which the amine compound and carboxylic acid compound can react to form the first ammonium salt can be used herein. In some embodiments, the amine compound and the carboxylic acid compound are contacted separately before being added to a reaction solution including a crude polycarbonate having an activator-second ammonium cation complex attached to at least one chain end. In certain embodiments, the solution includes tetahydrofuran, methanol, and water. In certain embodiments, the solution includes tetrahydrofuran and methanol combined in a 2:1 ratio. In other embodiments, the amine compound and the carboxylic acid compound are contacted in the reaction solution including the crude polycarbonate and the therefore the first ammonium salt is formed in the reaction solution, not prior to being added to the reaction solution.

The first ammonium salt, which is formed from a reaction between the amine compound and carboxylic acid compound in step (a), can include a first ammonium cation associated with a mono- or poly-functional carboxylate compound. The first ammonium cation can include a protonated form of the amine compound, whereas the carboxylate compound can include a deprotonated form of the carboxylic acid compound. For example, in some embodiments, the amine compound and carboxylic acid compound react to form a first ammonium salt with the following formula:

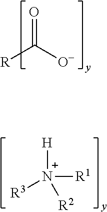

where each of R, R¹, R², R³, and y is defined above. In other embodiments, the first ammonium cation can include any compound having a positively charged nitrogen atom having up to four substituents. In some embodiments, for example, the first ammonium salt includes butylammonium succinate.

In step (b), the first ammonium salt is contacted with a reaction solution comprising polycarbonates that have been polymerized from epoxides and carbon dioxide, optionally in the presence of an initiator and activator, according to any of the methods disclosed in co-pending and co-owned U.S. patent application Ser. Nos. 15/571,631 and 15/803,011; and PCT Application No. PCT/IB2019/054109, each of which is hereby incorporated by reference in their entirety. In certain embodiments, the reaction solution comprises crude polycarbonates, which include crude or intermediate polycarbonates having an ate complex attached to at least one chain end. An ate complex is typically a complex formed between an activator and an organic cation. The organic cation can include an ammonium cation, such as a second ammonium cation, wherein the second ammonium cation is different from the first ammonium cation from step (a). Accordingly, in some embodiments, the reaction solution comprises a crude polycarbonate having an activator-second ammonium cation complex—or, simply, an ate complex—attached to at least one chain end.

The contacting in step (b) is not particularly limited. In certain embodiments, the contacting proceeds by adding the first ammonium salt to the reaction solution including crude polycarbonates. In certain embodiments, the contacting proceeds by mixing the first ammonium salt with said reaction solution. In certain embodiments, the contacting proceeds by mixing the first ammonium salt with a diluted reaction solution. The mixing can proceed by any means or technique known in the art, such as by stirring or other such similar means. In certain embodiments, the mixing can proceed for a select duration. For example, the mixing can proceed for a duration in the range of about 1 s to about 24 h, or any increment thereof, preferably less than about 5 h, more preferably less than about 2.5 h, most preferably for about 1 h or less. The conditions under which the contacting proceeds are also not particularly limited. In certain embodiments, the contacting proceeds at about room temperature, optionally at about atmospheric pressure and optionally in an inert environment. Other temperatures, pressures, and environments, however, can be utilized herein without departing from the scope of the present disclosure.

By adding the first ammonium salt to the reaction solution including the crude polycarbonates, a first solution can be obtained. The first solution can include a protonated polycarbonate, a second ammonium salt, and an activator adduct, each of which being formed as a result of the contacting (e.g., adding, mixing, etc.). While not wishing to be bound to a theory, it is believed that, upon the contacting or mixing, a proton from the first ammonium cation of the first ammonium salt is transferred to a propagating chain end of a growing crude polycarbonate, resulting in the corresponding release of the ate complex from that chain end and in the formation of the protonated polycarbonate. Having lost a proton, the first ammonium cation of the first ammonium salt can result in the (re-)formation of an amine compound that associates or binds with the activator portion of the ate complex, thereby forming the activator adduct. The other portion of the ate complex is an organic cation, preferably a second ammonium cation, that associates or binds with the carboxylate group of the first ammonium salt, forming a new or different ammonium salt, which is referred to herein as the second ammonium salt.

The activator, which associates with the amine compound, can include a borane compound. The borane compound can be selected from alkyl boranes and aryl boranes. For example, in some embodiments, the borane compound is a trialkyl borane or a triaryl borane. In certain embodiments, the trialkyl and triaryl boranes can be represented by the following formula:

B(R²)₃

wherein each R² is independently selected from substituted and unsubstituted alkyls and substituted and unsubstituted aryls, wherein the alkyls are selected from linear or branched alkyl groups, aromatic or non-aromatic alkyl groups, and carbocyclic or heterocyclic alkyl groups; wherein the aryls are selected from aryl groups and heteroaryl groups, each of which can be substituted or unsubstituted. For example, in an embodiment, each R² is selected from an ethyl, n-butyl, i-butyl, n-octyl, and phenyl group to provide triethyl borane, tributyl borane, triisobutyl borane, trioctyl borane, and triphenyl borane as the borane compound, respectively. In certain embodiments, the borane compound is triethyl borane.

The second ammonium cation, which associates or binds with the mono- or poly-functional carboxylate group, can include any compound having a positively charged nitrogen atom associated with up to four substituents. For example, in some embodiments, the second ammonium cation can have the following formula:

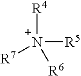

where each of R⁴, R⁵, R⁶, and R⁷ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, substituted or unsubstituted alkaryl, and the like. Non-limiting examples of suitable second ammonium cations include NBu₄⁺, NPh₄⁺, NOct₄⁺, N(allyl)₂(Me)₂⁺, and the like. For example, in some embodiments, the second ammonium salt includes poly(diallyldimethylammonium succinate) or diallyldimethylammonium succinate. In some embodiments, the second ammonium salt includes tetrabutylammonium succinate.

In step (c), the first solution containing the protonated polycarbonate, second ammonium salt, and activator adduct is contacted with a non-solvent. The contacting of the first solution with the non-solvent causes the protonated polycarbonate to precipitate out of solution, thereby obtaining a precipitated polycarbonate. The contacting of the first solution with the non-solvent can also cause the second ammonium salt to precipitate out of solution. Accordingly, in some embodiments, the contacting can be used to obtain precipitates, wherein the precipitates include a precipitated polycarbonate and/or second ammonium salt. The contacting can proceed by adding the first solution dropwise to the non-solvent. In some embodiments, the contacting is performed by washing. Other variations and techniques suitable for precipitating the polycarbonate can be utilized herein without departing from the scope of the present disclosure.

In step (d), the precipitated polycarbonate and second ammonium salt are separated from the activator adduct to obtain a second solution including the activator adduct. The separating can proceed by removing solutions, nonsolvents, and/or solvents. For example, in some embodiments, the separation is performed by centrifuging the mixture comprising the first solution and non-solvent from step (c). The centrifuging can be utilized to form separable layers. For example, in some embodiments, the centrifuging is utilized to form a layer comprising the precipitated polycarbonate and optionally the second ammonium salt, and a non-solvent layer comprising the activator adduct. The layer and non-solvent layer can be immiscible and thus can be phase separable layers. Upon the formation of such layers, the non-solvent layer can be separated from the other layer to obtain the second solution.

In step (e), the precipitated polycarbonate and second ammonium salt can be separated to obtain a purified polycarbonate and recover the second ammonium salt which can be recycled and reused for synthesizing additional polycarbonates. For example, in some embodiments, the second ammonium salt is separated from the precipitated polycarbonate through selective extraction to recover the second ammonium salt. In some embodiments, the precipitates including the precipitated polycarbonate and second ammonium salt from step (d) can be contacted with a solvent to re-dissolve the polycarbonate and subsequently contacted with a non-solvent, such as water, to re-precipitate the polycarbonate out of solution, leaving the second ammonium salt in aqueous solution. Centrifugation can be performed to separate and recover the purified polycarbonate from the second ammonium salt in the aqueous solution. Further processing can be required to separate and recover the second ammonium salt from the aqueous solution. For example, the further processing can include removing residual solvents by evaporation (e.g., rota evaporation) and lyophilizing to further dehydrate and recover the second ammonium salt.

In step (f), the activator adduct can be separated from the non-solvent mixture to obtain and recover the activator which can be recycled and reused for synthesizing additional polycarbonates. For example, the non-solvent mixture containing the activator adduct from step (d) can be subjected to distillation to separate the non-solvent mixture from the activator adduct. The conditions under which the distillation is carried out can be selected depending on the particular species present in the non-solvent mixture and activator adduct. Accordingly, the temperature, pressure, duration, and parameters of the distillation are not particularly limited. Following the distillation, the distillate bottoms or residue containing the activator adduct can be dissolved in a solvent and combined with an isocyanate compound, before being subjected to further distillation. The sub-steps of dissolving in a solvent and combining with an isocyanate compound can be performed one or more times until the activator is completely recovered. While not wishing to be bound to a theory, it is believed that the isocyante compound reacts with the activator adduct, which can be characterized as a complex formed between the amine compound and activator. Through that reaction, the activator is released and/or freed and thus capable of being recovered and optionally reused in the synthesis of additional polycarbonates.

The isocyanate compound can include any compound having an isocyanate group, such as tosyl isocyanate, alkyl isocyanates, and aromatic isocyanates. The isocyanate compounds include mono- and multi-functional (e.g., poly-functional) isocyanate compounds. A mono-functional isocyanate compound is an isocyanate compound comprising only one isocyanate group. A multi-functional isocyanate compound is an isocyanate compound comprising two or more isocyanate groups. The isocyanate compounds can be characterized by a functionality, x, that can range from 1 to n, where a functionality of 1 refers to a mono-functional isocyanate compound, a functionality of 2 refers to a bifunctional isocyanate compound or a diisocyanate compound, a functionality of 3 refers to a trifunctional isocyanate compound or a triisocyanate compound, and so on. The upper bounds of n is not particularly limited.

In some embodiments, the isocyanate compound has the following formula:

R⁸ [symbol] +N═C═O]ₓ

where R⁸ is selected from substituted or unsubstituted tosyl, substituted or unsubstituted alkyl, and substituted or unsubstituted aryl; x is a functionality of the isocyanate compound and can be in the range of 1 to n. Examples of isocyanate compounds include, but are not limited to, methyl isocyanate, ethyl isocyanate, n-propyl isocyanate, n-butyl isocyanate, t-butyl isocyanate, hexyl isocyanate, octyl isocyanate, dodecyl isocyanate, octadecyl isocyanate, hexadecyl isocyanate, cyclohexyl isocyanate, phenyl isocyanate, tosyl isocyanate, diphenylmethane diisocyanate, isophorone diisocyanate, toluene diisocyanate, hexamethylene diisocyanate, tetramethylxylene diisocyanate, p-phenylene diisocyanate, hydrogenated diphenylmethane diisocyanate, toluene diisocyanate, sulfonated diphenylmethanediisocyanate, m-phenylene diisocyanate, phenyl isocyanate, 2,4,-toluylene diisocyanate, 2,6-toluylene diisocyanate, toluyl isocyanate, 3,3′-dimethyl, 4,4′-biphenylene, diisocyanate, 3,3 dimethoxy-4,4′ biphenylene diisocyanate, 3,3 diphenyl-4,4′-biphenylene diisocyanate, 1-trichloro methyl-2,4-diisocyanato benzene, 2-isocyanato diphenyl ether, diphenyl sulfone-4-isocyanate, 3-isocyanato-acetophenone, diphenyl methane-4,4′-diisocyanate, di-phenyl-4,4′-diisocyanate, naphthalene-1,5-diisocyanate, triphenyl meth-3-ane-4,4′,″-triisocyanate, 4,4-diisocyanato diphenyl sulfone, among others.

In step (g) (not shown), the second ammonium salt, and/or initiator, recovered in step (e) and the activator recovered in step (f) can be recycled and/or reused in additional reaction cycles involving the synthesis of polycarbonates, including polycarbonate polyols. For example, in some embodiments, the method further comprises contacting an epoxide and carbon dioxide in the presence of one or more of a recovered initiator and recovered activator to form a polycarbonate. For example, in some embodiments, a difunctional initiator such as tetrabutylammonium succinate and an activator such as triethyl borane, either or both of which may be recovered from a previous reaction cycle, may be recycled or used in the synthesis of polycarbonates including polycarbonate polyols.

The epoxide monomer can be substituted or unsubstituted and functionalized or non-functionalized. In an embodiment, the epoxide monomer can be represented by the general structure below:

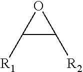

wherein each of R₁ and R₂ can be independently selected from hydrogen, alkyls, heteroalkyls, cycloalkyls, alkenyls, heteroalkenyls, cycloalkenes, alkynyls, heteroalkynyls, cycloalkynyls, alkoxys, aryls, heteroaryls, aralkyls, aralkylenes, alkaryls, alkarylenes, halogens, or combinations thereof, each of which can be substituted or unsubstituted. For example, the epoxide monomer can be selected from the following structures:

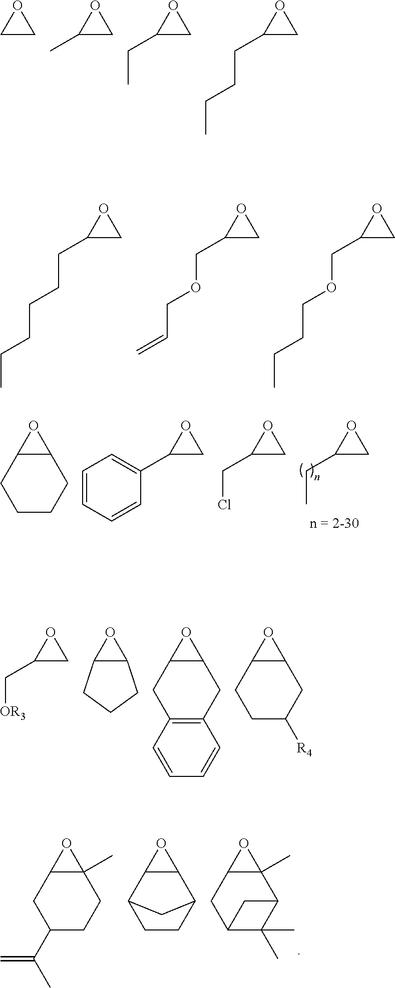

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Synthesis of Polycarbonate Polyol

A 50 mL Parr reactor with a magnetic stir bar and a small glass vial inside was first dried in an oven at 120° C. overnight and then immediately placed into a glove box chamber. After keeping under vacuum for 2 hours, the reaction vessel was moved into the glove box under argon atmosphere. The reactor was charged with TBAA (0.150 g 0.5 mmol), triethyl borane (0.5 mL, 1 Molar solution in THF, 0.5 mmol). Propylene oxide (0.7 mL, 10 mmol) was then added in the glass vial inside the reactor, the reactor was quickly sealed, taken out from the glove box and charged with CO₂ to a pressure of 10 bar and reaction was carried out at 40° C. for 14 h with stirring. The reactor was cooled, and the unreacted CO₂ was slowly released through the outlet valve until it reached a pressure of approximately 1 atm. Then argon was passed through the inlet valve and the outlet valve was kept open for argon purging (2 min) and it was moved inside the glovebox.

### Example 2

### Recovery and Reuse of TEB and Bu₄N⁺ Using (BuNH₃)Succinate

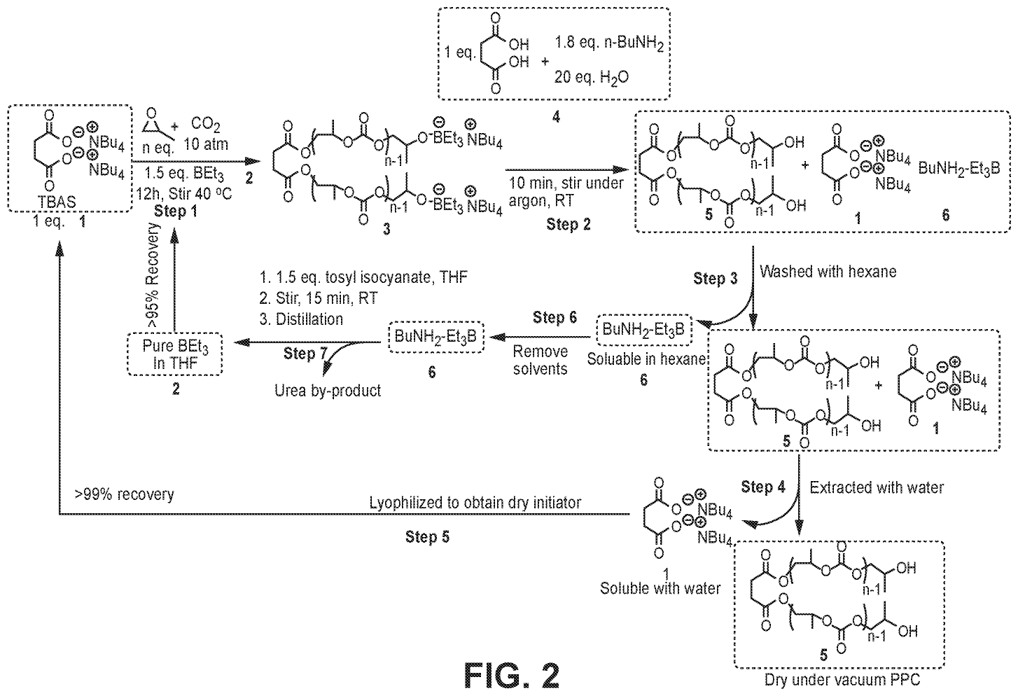

The reactor was opened and 0.32 mL (0.225 mmol) of pre-prepared butylammonium succinate solution [0.7 M in THF-Methanol (2:1)] was added and stirred 1 h. Then the whole polymer crude solution was added dropwise to hexane (25 mL) in a 50 mL centrifuge tube to precipitate the polycarbonate. After centrifugation, the hexane (+residual methanol) layer carrying BuNH₂-TEB adduct was separated carefully from the precipitated polymer. A reaction scheme for the recovery and reuse of triethyl borane and Bu₄N⁺ using (BuNH₃)-succinate is shown in FIG. 2, according to one or more embodiments of the present disclosure.

### Example 2A

### Recovery of Bu₄N⁺

For Bu₄N⁺ recovery, the precipitated polymer was re-dissolved in THF (2 mL) and precipitated in water (25 mL), where the pure propylene carbonate (PPC) precipitates out leaving the (Bu₄N)₂ succinate in aqueous solution. After centrifugation the aqueous layer was separated from PPC and rota evaporated to remove residual THF and subjected to lyophilization to recover (Bu₄N)₂ succinate.

### Example 2B

### Recovery of TEB

For triethyl borane recovery, the hexane layer (+residual MeOH) carrying BuNH2-TEB was subjected to distillation (40-50° C., Liq nitrogen cooled collection flask under static reduced pressure) to remove hexane and residual methanol. The distillation residue containing TEB-butylamine adduct added was dissolved in dry THF 3 mL. To that solution was added tosyl isocyanate (0.156 mL, 0.196 g, 1.0 mmol). Then the isocyanate solution was subjected to distillation (40-80° C., Liq nitrogen cooled collection flask under static reduced pressure) to distill the recovered TEB in THF (3 mL). The distillation residue was again dissolved 1.5 mL of dry THF and redistilled under the same condition to recover TEB completely from the viscous isocyanate residue.

### Example 3

### Synthesis of Polycarbonate Polyol

A 50 mL Parr reactor with a magnetic stir bar and a small glass vial inside was first dried in an oven at 120° C. overnight and then immediately placed into a glove box chamber. After keeping under vacuum for 2 hours, the reaction vessel was moved into the glove box under argon atmosphere. The reactor was charged with difunctional initiator tetrabutylammonium succinate (0.2 g 0.367 mmol), triethyl borane (1.03 mL, 1 Molar solution in THF, 1.03 mmol), and THF (1.0 mL). The propylene oxide (2.05 mL, 29.3 mmol) was then added in the glass vial inside the reactor, the reactor was quickly sealed, taken out from the glove box and charged with CO₂ to a pressure of 10 bar and reaction was carried out at 40° C. for 14 h with stirring. The reactor was cooled, then the unreacted CO₂ was slowly released and the polymer solution was diluted with THF and stirred for 10 min. A mixture of succinic acid (39.4 mg, 0.33 mmol), n-butyl amine (0.12 mL, 1.2 mmol), and deionized water (0.120 mL, 6.66 mmol) was added to the reaction mixture and stirred for 10 min. The whole solution was precipitated using hexane and stirred vigorously. The organic layer was separated for the recycling of TEB. The polymer was precipitated using deionized water, and the crude product at the bottom was further washed with deionized water. After decanting, the polymer (PPC diol) was collected and dried in vacuum at 40° C. The aqueous layers were merged to recycle soluble ditetrabutylammonium succinate in the next step.

### Example 4A

### Recovery of Bu₄N⁺

The collected aqueous layer was concentrated to be dryness and then further purified by lyophilization. The recovered tetrabutylammonium salts could be used into the next cycle of polymerization.

### Example 4B

### Recovery of TEB

The hexane layer obtained above was concentrated to remove hexane, THF, and excess n-butylamine. The residue containing TEB-butylamine adduct was dissolved in 0.5 mL of dry THF. To that formed solution was added tosyl isocyanate (0.150 mL, 1.0 mmol). Then this solution was subjected to distillation (40-80° C.) under static reduced pressure; to recover TEB completely from urea containing solution. Triethylborane, together with THF was collected, and the recycling yield found was 95%.

### Example 5

### Synthesis of Polymeric Initiator Poly(diallyldimethylammonium succinate)

In a 250 mL round bottom flask equipped with stir bar, a 40% poly(diallyldimethylammonium chloride) (PDAMAC) solution in water was transferred to the anion exchange resin and stirred for 48 h at 40° C., allowing to exchange chloride ions of PDADMA-Cl to hydroxide ions PDADMA-OH. The ion exchange resin was removed by filtration; the obtained PDADMA-OH (3 g, 21.1 mmol) was dissolved in 20 mL of deionized water, succinic acid (1.25 g, 10.5 mmol) was added to the above solution. The completion of the neutralization reaction was followed by the phenolphthalein indicator. Then the water was removed from the reaction mixture by lyophilization to obtain PDADMA-Succinate as a white powder.

### Example 6

### Synthesis of Polycarbonate Polyol

A 50 mL Parr reactor with a magnetic stir bar and a small glass vial inside was first dried in an oven at 120° C. overnight and then immediately placed into a glove box chamber. After keeping under vacuum for 2 hours, the reaction vessel was moved into the glove box under argon atmosphere. Dried poly(diallyldimethylammonium succinate) (0.2 g, 0.59 mmol succinate) was placed into the bottom of the reactor. Over this 1M solution of TEB in THF (1.76 mL, 1.76 mmol) was added and then stirred for 5 min; then propylene oxide (1.65 mL, 23.5 mmol) was quickly added, the reactor was sealed immediately, taken out from the glove box and charged with CO₂ to a pressure of 10 bar. The copolymerization was carried out at 50° C. for 14 hr., the reactor after completion of CO₂/PO copolymerization was cooled to room temperature, and CO₂ was released up to 1 bar. The reactor was transferred to the glove box and opened after the release of all CO₂. A small amount of THF was added to reduce the viscosity of the reaction mixture. A mixture of succinic acid (69.4 mg, 0.59 mmol), n-Butyl amine (0.218 mL, 2.1 mmol), and deionized water (0.59 mL, 5.9 mmol) was transferred to the reaction mixture and stirred for 10 min. The reactor was taken out of the glove box, and about 10 mL of THF was added, upon centrifugation of the collected reaction medium PDADMA-Succinate was isolated as a precipitate. This PDADMA-Succinate was washed again with THF, and then dried to get pure PDADMA-S as an initiator. The collected THF fractions were concentrated and precipitated using 30 mL of hexane; the precipitated polymer was separated by centrifugation. The copolymer was collected and dried in a vacuum. The organic hexane fraction was evaporated under reduced pressure on a rotary evaporator to get TEB-butyl amine adduct. The recovery of TEB is same as Example 4B. In an inert atmosphere, the dried TEB-butyl amine adduct was diluted with THF (0.5 mL), and tosyl isocyanate (0.27 mL, 1.76 mmol) was added and stirred for 10 min; after the complete reaction, the freed TEB along with THF was distilled under reduced pressure to get pure TEB for next cycle of polymerization.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of recovering and optionally reusing an activator and initiator following polycarbonate synthesis, comprising:
(a) contacting an amine compound with a carboxylic acid compound to form a first ammonium salt, the first ammonium salt including a first ammonium cation associated with a carboxylate group;
(b) mixing the first ammonium salt with a reaction solution comprising a crude polycarbonate having an activator-second ammonium cation complex attached to at least one chain end to obtain a first solution comprising a protonated polycarbonate, an activator adduct, and a second ammonium salt in which the second ammonium cation is associated with the carboxylate group from the first ammonium salt;
(c) contacting the first solution with a non-solvent to precipitate the polycarbonate and second ammonium salt out of solution;
(d) separating the activator adduct from the precipitated polycarbonate and the second ammonium salt to obtain a second solution including the activator adduct;
(e) separating the precipitated polycarbonate from the second ammonium salt to recover the second ammonium salt, wherein the second ammonium salt is capable of being reused as an initiator for synthesizing additional polycarbonates; and
(f) separating the activator adduct from the second solution to recover an activator capable of being reused for synthesizing additional polycarbonates, wherein the separating includes treating with an isocyanate compound.

2. The method according to claim 1, wherein the amine compound is selected from the group consisting of primary amines, secondary amines, tertiary amines, and aromatic amines.

3. The method according to claim 1, wherein the amine compound has the following formula: 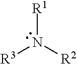
where each of R¹, R², and R³ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl.

4. The method according to claim 1, wherein the carboxylic acid compound includes mono-functional carboxylic acids or poly-functional carboxylic acids.

5. The method according to claim 1, wherein the carboxylic acid compound has the following formula: 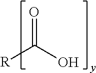
wherein R is selected from the group consisting of substituted and unsubstituted alkyl, substituted and unsubstituted heteroalkyl, substituted and unsubstituted alkenyl, substituted or unsubstituted alkynyl, substituted and unsubstituted aryl, substituted and unsubstituted heteroaryl, substituted and unsubstituted aralkyl, and substituted and unsubstituted alkaryl; and y is the functionality of the carboxylic acid compound and is at least 1.

6. The method according to claim 1, wherein the first ammonium salt has the following formula: 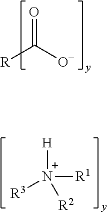
where each of R, R¹, R², and R³ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl; and y is at least 1.

7. The method according to claim 1, wherein the activator adduct includes an activator and the amine compound.

8. The method according to claim 7, wherein the activator is selected from the group consisting of triethyl borane, tributyl borane, triisobutyl borane, trioctyl borane, and triphenyl borane.

9. The method according to claim 1, wherein the second ammonium cation is selected from the group consisting of NBu₄⁺, NPh₄⁺, NOct₄⁺, and N(allyl)₂(Me)₂⁺.

10. The method according to claim 1, wherein the second ammonium salt has the following formula: 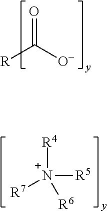
where each of R, R⁴, R⁵, R⁶, and R⁷ is independently selected from hydrogen, substituted or unsubstituted alkyl, substituted or unsubstituted aryl, substituted or unsubstituted heteroalkyl, substituted or unsubstituted alkenyl, substituted or unsubstituted alkynyl, substituted or unsubstituted heteroaryl, substituted or unsubstituted aralkyl, or substituted or unsubstituted alkaryl; and y is at least 1.

11. The method according to claim 1, wherein the first ammonium cation and second ammonium cation are different.

12. The method according to claim 1, wherein the separating in step (d) proceeds by centrifuging to obtain phase separable layers comprising a first layer and a second layer, wherein the first layer includes the precipitated polycarbonate and second ammonium salt and the second layer includes the activator adduct.

13. The method according to claim 1, wherein the separating in step (e) proceeds by re-dissolving the polycarbonate and subsequently contacting with a non-solvent to re-precipitate the polycarbonate out of solution, leaving the second ammonium salt in solution.

14. The method according to claim 13, wherein the separating in step (e) further proceeds by lyophilizing the second ammonium salt in solution to recover the second ammonium salt therefrom.

15. The method according to claim 1, wherein the separating in step (f) proceeds by distilling the second solution to obtain a distillate residue.

16. The method according to claim 15, wherein the distillate residue is treated with the isocyanate compound to recover the activator.

17. The method according to claim 1, wherein the isocyanate compound includes tosyl isocyanate, alkyl isocyanates, or aromatic isocyanates.

18. The method according to claim 1, wherein the isocyanate compound has the following formula:
R⁸ [symbol] +N═C═O]ₓ
where R⁸ is selected from substituted or unsubstituted tosyl, substituted or unsubstituted alkyl, and substituted or unsubstituted aryl; and x is at least 1.

19. The method according to claim 1, further comprising contacting an epoxide and carbon dioxide in the presence of the recovered initiator and activator to form polycarbonates.

20. The method according to claim 19, wherein the epoxide is selected from one of the following: [chemical structure]
